(19) United States
(12) Patent Application Publication
(10) Pub. No.: US 2020/0029670 A1
(43) Pub. Date: Jan. 30, 2020

(54) HOT/COLD AND MOISTURE TRANSFERRING MASK AND KIT FOR FACILITATING AND ENHANCING SHAVING

(71) Applicant: BEARD BLANKET LLC, Yonkers, NY (US)

(72) Inventors: Marcos Acosta, Yorktown Heights, NY (US); Michael Gregorio, Yonkers, NY (US)

(73) Assignee: BEARD BLANKET LLC, Yonkers, NY (US)

(21) Appl. No.: 16/524,783

(22) Filed: Jul. 29, 2019

Related U.S. Application Data
(63) Continuation-in-part of application No. 29/682,445, filed on Mar. 5, 2019.
(60) Provisional application No. 62/711,843, filed on Jul. 30, 2018.
(60) Provisional application No. 62/814,130, filed on Mar. 5, 2019.

(51) Int. Cl. A45D 27/00; A45D 27/22; B32B 5/02; B32B 27/34; B32B 25/16; B32B 25/08; B32B 25/10

(52) U.S. Cl. CPC A45D 27/003; A45D 27/22; B32B 5/02; B32B 27/34; B32B 2555/00; B32B 25/08; B32B 25/10; A45D 2200/25; B32B 2250/03; B32B 25/16

(57) ABSTRACT

A skin treatment mask including a length of material configured to approximate a body surface, the length of material including a first cloth layer configured to retain moisture, a second rubber-like layer secured atop the first cloth layer, and a third resilient layer secured atop the second rubber-like layer. A kit including the mask and a method of use are also disclosed.

### CROSS REFERENCE TO RELATED APPLICATIONS

This application relates to and claims priority from U.S. Prov. Pat. App. Ser. 62/711,843, which was filed on Jul. 30, 2018, U.S. Prov. Pat. App. Ser. No. 62/814,130, which was filed Mar. 5, 2019, and U.S. Des. Pat. App. Ser. No. 29/682,445, which was filed Mar. 5, 2019, the entire contents of each of which are hereby incorporated herein by reference.

### FIGURE SELECTED FOR PUBLICATION

FIG. 4

### BACKGROUND OF THE INVENTION

### Field of the Invention

The present invention generally relates to shaving accessories and more particularly to a hot/cold and moisture transferring mask or covering for facilitating and enhancing shaving.

### Description of the Related Art

Most shaving products on the market instruct the customer to take a hot shower as a pre-shave step to open skin pores and soften the hairs in order to maximize the effectiveness of their product and obtain the smoothest and closest shave. In reality, most people don't have the time to take a hot shower prior to shaving and end up shaving with just the product, which completely removes or minimizes the benefits of the underlying product. Furthermore, current shaving products are full of chemicals that claim to help in shaving and preventing related side effects such as razor burns, razor bumps, ingrown hairs and folliculitis. These products are artificial substitutes for the use of hot and cold water. And many consumers have legitimate health concerns about the use of chemicals. Simply put there are no products on the market that can facilitate the simple natural facial hair pre-shave effect of hot water and the post shave effect of cold water.

As can be seen, there is a need for hot/cold and moisture transferring mask for facilitating and enhancing shaving. The mask, in essence, is a delivery system for temperature and moisture to user's face. As a pre-shave method, the heat and moisture from hot water relaxes the skin and opens the skin pores. Relaxed skin will create an even surface for the razor blade to glide over the skin for a very close and smooth shave. The heat also facilitates the release of dirt and sebum from within the pores which is important not only for a cleaner complexion but also to clear anything that could have been coating the base of the hair and preventing it from fully absorbing water. The moisture delivery of the mask allows the facial hairs to absorb water, thereby expanding them and making them easier to cut. This is desired because it reduces the potential of blade tugging and prevents an inconsistent shave. Lastly the combination of heat and moisture not only provides a vast amount of benefits to the user, but also prolongs the life of the razor by reducing wear on the blade as it does not have to work as hard to cut through the hairs.

The cold and moisture delivery properties of the mask facilitate and enhance the post shaving experience. As a post shave method, the mask delivers cold and moisture to the user's face thus providing hydration to the skin, closing the pores and producing a cooling effect without the use of irritating chemicals commonly used in post shaving products.

As a pre-shave method, the user need only apply hot water to the hot/cold and moisture transferring mask, which is adapted to retain the heat and moisture of the hot water and in turn deliver the heat and moisture upon application to the user's hair and skin pores. As a post shave method, a user need only apply cold water to the temperature and moisture transferring mask which is adapted to retain the cold and moisture of the cold water and in turn, deliver the cold and moisture upon application to the user's skin after shaving. Thereby, the present invention eliminates the use of chemicals commonly found on pre and post shaving products and further eliminates the lengthy process of showering prior to shaving by delivering the natural effects of temperature and moisture of hot and cold water in a face mask dimensioned and adapted for convenient application.

### ASPECTS AND SUMMARY OF THE INVENTION

In an embodiment, a skin treatment mask may include a length of material configured to approximate a body surface, the length of material including: a first cloth layer configured to retain moisture; a second rubber-like layer secured atop the first cloth layer; and a third resilient layer secured atop the second rubber-like layer. The length of material may include a first end and a second end, and further comprises a first fastener member secured to the first end and a second fastener member secured to the second end, the first and second fastener members being configured to be secured to one another. The body surface may be a face, a head, a beard, a genital region, but is not limited thereto. The mask may also include a pocket secured to the third resilient layer such that shaving supplies can be received and stored within the pocket.

According to one alternative aspect of the invention, there is provided a skin treatment mask, comprising: a length of material configured to approximate a body surface, the length of material including: a first cloth layer configured to retain moisture, a second rubber-like layer secured atop the first cloth layer, and a third resilient layer secured atop the second rubber-like layer.

According to one alternative aspect of the invention, there is provided a skin treatment mask, wherein: the length of material includes a first end and a second end, and further comprises a first fastener member secured to the first end and a second fastener member secured to the second end, the first and second fastener members being configured to be secured to one another.

According to one alternative aspect of the invention, there is provided a skin treatment mask, wherein: the body surface is a face, and wherein the length of material is configured to approximate facial contours, and wherein the length of material includes a first half and a second half that are joined to one another at a seam, and wherein the shape of the seam is configured to accommodate a nose and a chin.

According to one alternative aspect of the invention, there is provided a skin treatment mask, wherein: the body surface is a genital region, and wherein the length of material is configured to approximate contours of the genital region, and further comprising: a fastening member that is elastically coupled to the material, the fastening member being configured to contact a posterior body surface and to urge the length of material in closer proximity to the body surface.

According to one alternative aspect of the invention, there is provided a skin treatment mask, wherein the body surface is a top of a human head, and wherein the length of material is configured to approximate contours of the human head.

According to one alternative aspect of the invention, there is provided a skin treatment mask, wherein: a pocket secured to the third resilient layer.

According to one alternative aspect of the invention, there is provided a kit for skin treatment, comprising: a skin treatment mask, further comprising: a length of material configured to approximate a body surface, the length of material including: a first cloth layer configured to retain moisture, a second rubber-like layer secured atop the first cloth layer, and a third resilient layer secured atop the second rubber-like layer, shaving supplies, and a pocket secured to the third resilient layer, the pocket being configured to receive the shaving supplies.

According to one alternative aspect of the invention, there is provided a kit for skin treatment, wherein: the shaving supplies include at least one of a towel, a razor, soap, and shaving cream.

According to one alternative aspect of the invention, there is provided a kit for skin treatment, wherein: the body surface is a face and the length of material is configured to conform to facial structures and wherein the length of material includes a first half and a second half that are joined to one another at a seam, and wherein the shape of the seam is configured to accommodate a nose and a chin.

According to one alternative aspect of the invention, there is provided a kit for skin treatment, wherein: the body surface is a genital region and the length of material of configured to conform to genital structures.

According to one alternative aspect of the invention, there is provided a kit for skin treatment, wherein: the body surface is a top of a human head and the length of material is configured to conform to the human head.

According to one alternative aspect of the invention, there is provided a kit for skin treatment, wherein: a box configured to be received within the pocket, the box being configured to house the shaving supplies.

A kit may include the skin treatment mask and may also include shaving supplies and/or tools, including, but not limited to a razor and towel.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a perspective view of a face mask in accordance with an embodiment of the present disclosure shown in a first state with ends secured to one another.

FIG. 2 is a front view of the face mask of FIG. 1.

FIG. 3 is a back view of the face mask of FIG. 1.

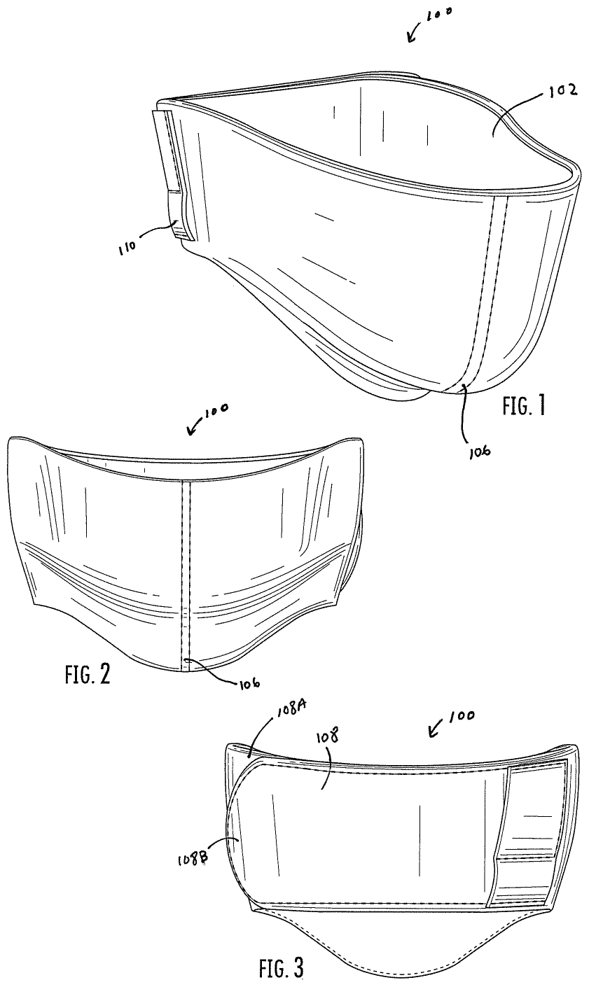

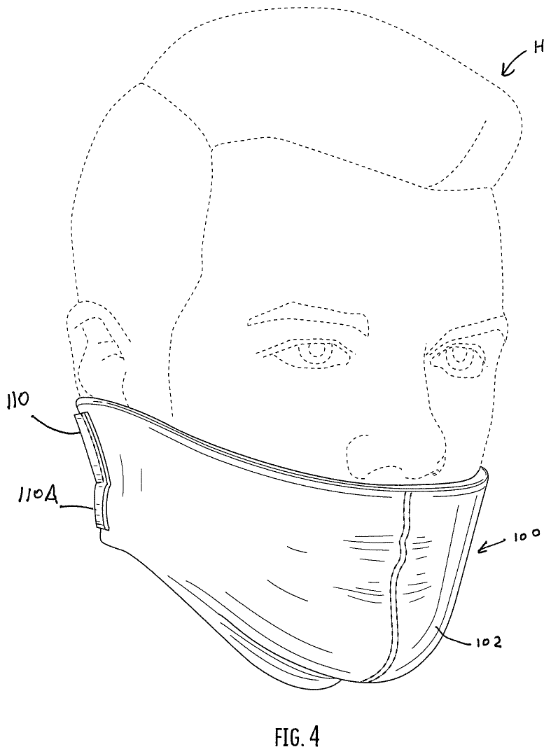

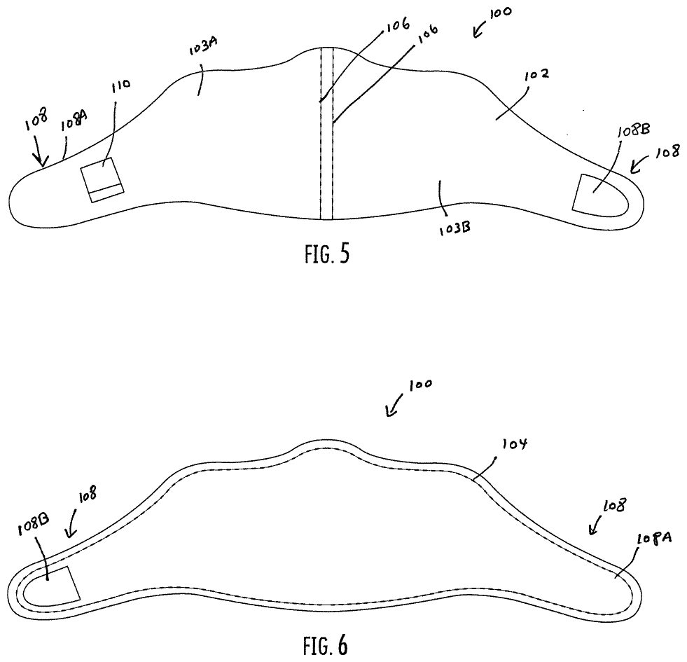

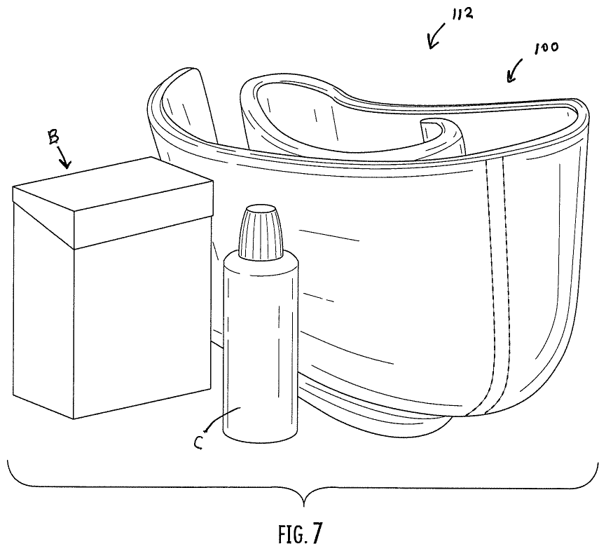

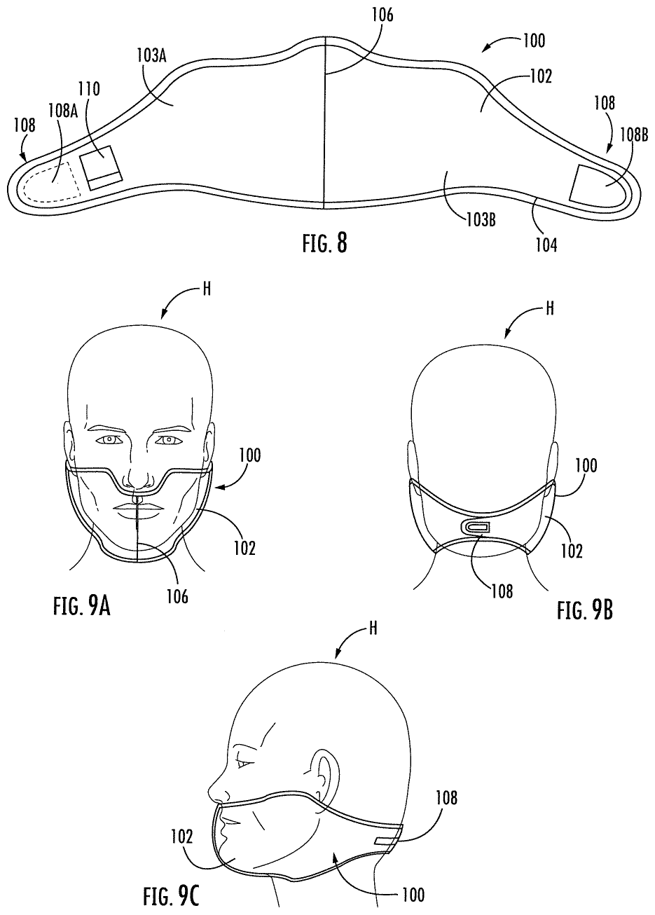

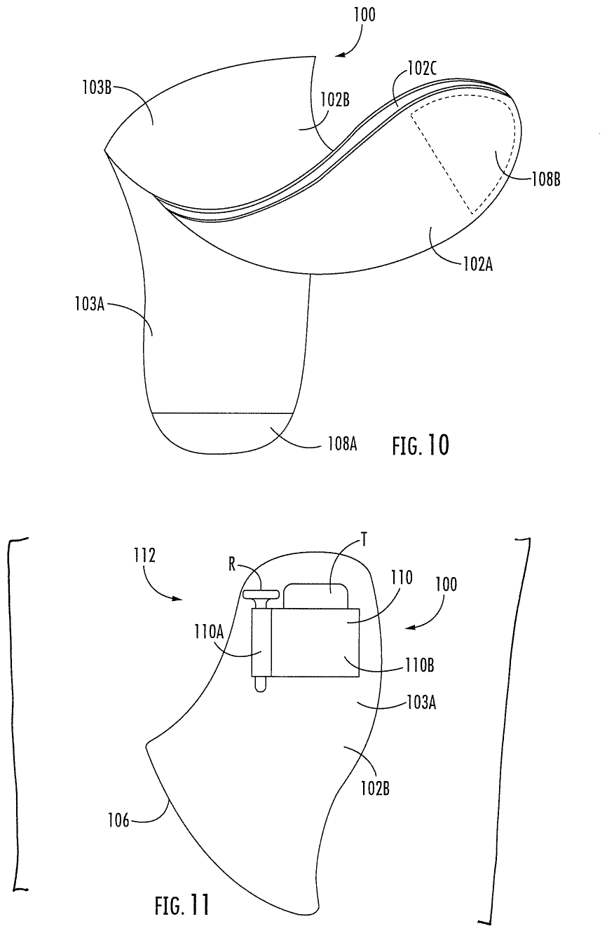

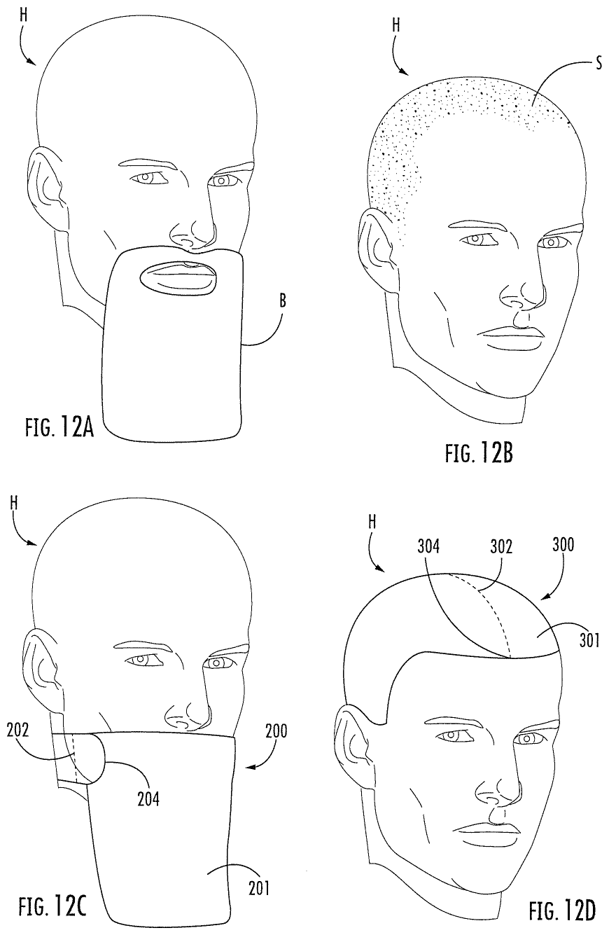

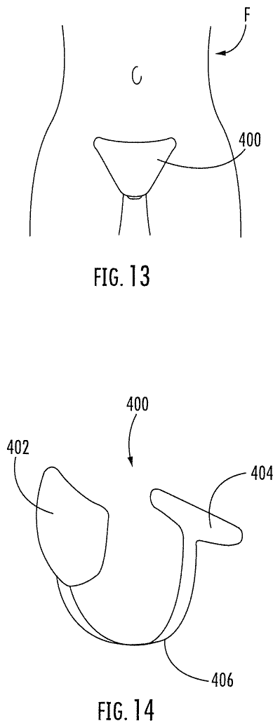

FIG. 4 is a perspective view of the face mask of FIG. 1 shown in use.

FIG. 5 is a front view of the face mask of FIG. 1 shown in a second state in which the face mask is unfolded.

FIG. 6 is a back view of the face mask of FIG. 1 shown in the second state.

FIG. 7 is a perspective view of a kit including the face mask of FIG. 1.

FIG. 8 is front view of the face mask of FIG. 1 shown in an unfolded state.

FIG. 9A is a front view of the face mask of FIG. 1 shown in use.

FIG. 9B is a rear view of the face mask of FIG. 1 shown in use.

FIG. 9C is a side view of the face mask of FIG. 1 shown in use.

FIG. 10 is a side perspective view of the face mask of FIG. 1.

FIG. 11 is a side view of the face mask of FIG. 1.

FIG. 12A is a perspective view of a bearded man.

FIG. 12B is a perspective view of a man with a shaved or buzzed head.

FIG. 12C is a perspective view of the bearded man of FIG. 12A using a beard mask in accordance with the present disclosure to prepare his beard for grooming.

FIG. 12D is a perspective view of the man of FIG. 12B using a head mask to prepare his head for shaving.

FIG. 13 is a front partial view of a woman using an intimate area mask in accordance with the present disclosure.

FIG. 14 is a perspective view of the intimate area mask in accordance with the present disclosure.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale.

A facial mask 100 is described with reference to FIGS. 1-11, which is configured to provide heat and moisture to facial skin in preparation for shaving the skin and removing hair from the skin.

The facial mask 100 may be include a length of material 102 that includes a composite of three layers including: a terry cloth facial surface 102A, an upper nylon layer 102B, and an intermediate layer 102C which may be formed from a neoprene or rubber-like material. The cloth facial surface 102A may be configured to absorb moisture such that when exposed to cold water, the facial surface 102A absorbs the cold water, thereby becoming moist and cold, and when exposed to warm water, the facial surface 102A absorbs the warm water, thereby becoming moist and warm. The facial mask 100 may further include a stitched border 104 that reinforces the border of the mask 100 and inhibits separation of the three layers 102A, 102B, and 102C.

In addition, seam 106 along the center of the mask 100 may form a configuration or shape corresponding to a general human facial shape or configuration. The facial mask 100 may have a unitary shape or may be formed in two halves 103A and 103B which may be secured to one another by the seam 106 to facilitate forming the desired general shape or configuration that generally corresponds to a facial shape. In addition, at opposing ends 108 of the mask 100 may include VELCRO type or hook and loop type fasteners such that the mask 100 may be sized appropriately to be worn on a user's face. Additionally or alternatively, the first layer 102A may be partially or entirely formed from a material that releasably secures to the second layer 102B via, for example, a VELCRO type or hook and loop type connection or via a magnetic connection.

Advantageously, unlike a conventional towel, the mask 100, as well as the beard mask 200, the head mask 300, and the intimate area mask 400 which are described below, the mask 100 is configured to lay flat against the skin and anatomical structures, whereas without being so shaped and configured, a flat towel would be unable to be pressed flat against the skin without some areas of the towel being spaced apart from the skin. By having a contour that is closer to the contour of the skin to which the mask 100 is to be applied, the mask 100 more closely approximates the unique anatomical structures than could a conventional flat towel.

Other advantages of the mask 100 include having more than one layer, e.g., a first layer that is configured to absorb liquid and another layer atop the first that is configured to retain moisture between the first layer and the skin. In contrast, a conventional towel material is typically formed from a single material, e.g., cotton.

The mask 100 may be secured around a user's head H by securing the opposing ends 108 via the fasteners on the ends 108A, 108B on the opposing ends 108 of the mask 100. The mask 100 as shown in FIG. 8 is in the unfolded state and is substantially similar to the masks 100 as shown in FIGS. 5 and 7 also in unfolded states. It is noted that various seam structures may be used so as to facilitate the mask 100 in approximating the facial contours when worn. For example, a single seam 106 may be used in which the halves 103A and 103B are adhered or glued to one another or as shown in FIG. 1, the two halves 103 and 103B may be stitched to one another in various stitching styles. Having the seam 106 dividing the two halves 103A and 103B relatively symmetrically may facilitate the mask 100 in approximating the facial contours when worn to accommodate facial anatomical structures such as the nose and chin. In FIGS. 9A-9C, the head H is shown as visible through the mask 100 such that it can be appreciated that when worn, the mask 100 generally approximates the shape of the head H.

The mask 100 has several advantageous and convenient features. In particular, the mask 100 may include halves 103A and 103B that when not used are configured to lay relatively flat one atop the other which is desirable for storing the mask 100. In addition, as shown in FIGS. 1 and 4, the mask may include a pocket 110, for example, on half 103A.

As shown in FIG. 7, a kit 112 may include the mask 100 as well as tools including a box B which may include shaving supplies, such as, a razor R, shaving cream C, a towel T, and the like. The mask 100 may include a pocket 110 that may include a first compartment 110A which may secure a razor R and a second compartment 110B which may secure a towel therein. The pocket 110 may be formed from the same three-layered material of the facial mask 100 including a length of material that may include a plurality of layers, including layers 102A, 102B, and 103C. The neoprene or rubber-like material of layer 102B may have a resilience or stretchability, which may facilitate snuggly receiving objects in the compartments 110A and 110B of the pocket 110. In addition, a removal liner that is formed from a hydrophilic material, e.g., water absorbent material may be removably adhered to the skin facing layer 102A, which may be desirable for hygienic reasons and to prolong the life of the mask 100.

During use, the mask 100 may be used for both pre and post shaving skin and hair preparation. In particular, prior to use, the mask 100 may be rinsed under warm water such that the skin contacting layer 102A is wetted and warmed and then the mask 100 may be worn for a desired length of time (e.g., 45 seconds) to prepare the skin and hair for shaving. Thereafter, the mask 100 may be removed and the facial surface may be shaved with looser pores and thicker hair that has absorbed the moisture of the water. After completion of the shave, the mask 100 may be rinsed in cold water such that the skin contacting layer or surface 102A may be wetted and cooled. Then, the mask 100 may be worn once again to cool the skin to tighten the pores and create a cooling sensation for a desired length of time (e.g., 25 seconds). In addition, to water, the mask 100 may also be infused with essential oils which may be sprayed upon the skin contacting layer or surface 102A. Traditional aftershave, which often includes undesirable oils, need not be used.

It should be appreciated that the present invention is not limited to use on any particular body part and more generally relates to providing a hot/cold and moisture transferring mask, which may be worn on various body parts, for facilitating and enhancing shaving to facilitate the application of hot/cold and moisture of hot and cold water to a user's skin and hair. The hold/cold and moisture transferring mask or covering may be removably and adjustably be secured by way of hook and loop fasteners, i.e., VELCRO® type fasteners for a desired length of time so as to deliver hot/cold temperature and moisture to the user's facial hair and skin prior to and subsequent to saving, thereby opening skin pores, softening the hairs, and producing a closer and smoother shave. When used as a post-shave method, the mask or cover delivers cold and moisture to the user's recently shaved area resulting in the closing of pores, hydration of the skin and the cooling feeling of freshness.

Other body parts and tasks to which similar masks may be employed include: beard trimming and treatment, head hair shaving, and intimate area body shaving.

As shown in FIGS. 12A and 12C, a man with a beard B may utilize a beard mask 200 which may include a length of material 201 that is substantially the same as the three-layered material 102 described above, except that it is shaped and sized to receive a beard therein, e.g., the length of material 201 may be cylindrically or conically shaped. The material 201 may be configured to include the same features of the mask 100 including a fastening system including a first surface 202 having a hook/fastener means and second surface 204 having a hook/fastener means. The beard mask 200 may be worn and used in the same manner as described above with respect to the facial mask 100 including warming and moistening the mask, applying the mask to the skin, removing the mask, shaving, cooling and moistening the mask, applying essential oils, and applying the mask once again to the skin.

As shown in FIGS. 12B and 12D, a man desiring to shave his head may utilize a head mask 300 which may include a length of material 301 that is substantially the same as the three-layered material 102 described above, except that it is shaped and sized to receive a beard therein, e.g., the length of material 301 may be shaped like a cap or beanie. The material 301 may be configured to include the same features of the mask 100 including a fastening system including a first surface 302 having a hook/fastener means and second surface 304 having a hook/fastener means. In particular, the material 301 may generally be shaped hemispherically to correspond to a head shape and may include a cut from a center point of the material to a circumferential end of the shape such that the first and second surfaces 302, 304 may overlap one another to effect tightening or loosening of the head mask 300 when used. The head mask 300 may be worn and used in the same manner as described above with respect to the facial mask 100 including warming and moistening the mask, applying the mask to the skin, removing the mask, shaving, cooling and moistening the mask, applying essential oils, and applying the mask once again to the skin.

As shown in FIGS. 13-14, an intimate area mask 400 may include a first member 402 that may be formed from the same three-layered material 102 that has been described throughout and may be configured to correspond and be applied to the genital region. The intimate area mask 400 may include an opposing surface 404 which may be secured to the first member 402 via a biasing member 406 which may be formed from a shape memory material which may be covered by a generally soft fabric material or the same three-layered material 102 such that skin is protected from the shape memory material. The shape memory material may be, for example, Nitinol or the like such that the first member and the opposing surface 404 are biased toward one another. When worn, the first member 402 may press against and contact the genital region and the opposing surface 404 may contact and press against the backside of the person, thereby urging the first member 402 to approximate the genital region more closely.

The intimate area mask 400 may be worn and used in the same manner as described above with respect to the facial mask 100 including warming and moistening the mask, applying the mask to the skin, removing the mask, shaving, cooling and moistening the mask, applying essential oils, and applying the mask once again to the skin.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A skin treatment mask, comprising:
a length of material configured to approximate a body surface, the length of material including:
a first cloth layer configured to retain moisture,
a second rubber-like layer secured atop the first cloth layer, and
a third resilient layer secured atop the second rubber-like layer.

2. The skin treatment mask of claim 1, wherein:
the length of material includes a first end and a second end, and further comprises a first fastener member secured to the first end and a second fastener member secured to the second end, the first and second fastener members being configured to be secured to one another.

3. The skin treatment mask of claim 1, wherein:
the body surface is a face, and wherein the length of material is configured to approximate facial contours, and wherein the length of material includes a first half and a second half that are joined to one another at a seam, and wherein the shape of the seam is configured to accommodate a nose and a chin.

4. The skin treatment mask of claim 1, wherein:
the body surface is a genital region, and wherein the length of material is configured to approximate contours of the genital region, and further comprising:
a fastening member that is elastically coupled to the material, the fastening member being configured to contact a posterior body surface and to urge the length of material in closer proximity to the body surface.

5. The skin treatment mask of claim 1, wherein:
the body surface is a top of a human head, and wherein the length of material is configured to approximate contours of the human head.

6. The skin treatment mask of claim 1, further comprising:
a pocket secured to the third resilient layer.

7. A kit for skin treatment, comprising:
a skin treatment mask, further comprising:
a length of material configured to approximate a body surface, the length of material including:
a first cloth layer configured to retain moisture,
a second rubber-like layer secured atop the first cloth layer, and
a third resilient layer secured atop the second rubber-like layer,
shaving supplies, and
a pocket secured to the third resilient layer, the pocket being configured to receive the shaving supplies.

8. The kit of claim 7, wherein:
the shaving supplies includes at least one of a towel, a razor, soap, and shaving cream.

9. The kit of claim 7, wherein:
the body surface is a face and the length of material is configured to conform to facial structures and wherein the length of material includes a first half and a second half that are joined to one another at a seam, and wherein the shape of the seam is configured to accommodate a nose and a chin.

10. The kit of claim 7, wherein:
the body surface is a genital region and the length of material of configured to conform to genital structures.

11. The kit of claim 7, wherein:
the body surface is a top of a human head and the length of material is configured to conform to the human head.

12. The kit of claim 7, further comprising:
a box configured to be received within the pocket, the box being configured to house the shaving supplies.
